(19) United States
(12) Patent Application Publication
(10) Pub. No.: US 2018/0217235 A1
(43) Pub. Date: Aug. 2, 2018

(54) Projection System for a Time-of-Flight Sensor and Method of Operation of Same

(71) Applicant: 4Sense, Inc., Delray Beach, FL (US)

(72) Inventor: Stanislaw K. Skowronek, New York, NY (US)

(73) Assignee: 4Sense, Inc., Delray Beach, FL (US)

(21) Appl. No.: 15/418,054

(22) Filed: Jan. 27, 2017

(51) Int. Cl. G01S 7/481; G01S 17/66; G01S 17/10; G01S 17/89

(52) U.S. Cl. CPC G01S 7/4814; G01S 17/89; G01S 17/102; G01S 17/66

(57) ABSTRACT

A system and method for reducing multipath propagation is described herein. Modulated light may be diffusively emitted in a monitoring area for the purpose of determining depth distances. If an object is present, the object can be passively tracked. A vicinity occupied by the object may be identified as a high-interest vicinity, and vicinities unoccupied by the object may be designated as low-interest vicinities. The diffusive emission of the modulated light may be maintained with respect to the high-interest vicinity. Simultaneous to maintaining the diffusive emission of the modulated light with respect to the high-interest vicinity, the diffusive emission of the modulated light with respect to the low-interest vicinities may be ceased such that the amount of modulated light reaching the low-interest vicinities is reduced. A depth distance of the object may be determined.

### FIELD

The subject matter described herein relates to time-of-flight (ToF) sensors and more particularly, to systems for controlling the illumination of the ToF sensors.

### BACKGROUND

Several companies develop and manufacture ToF sensors, which are designed to illuminate an area with light, typically in the near-infrared range of the light spectrum, that has been modulated with an input signal and to capture reflections of the modulated light from objects in the area. The ToF sensor may detect phase shifts of the input signal modulating the light and may translate these differences into distances between the ToF sensor and the objects.

In accordance with its operation, a ToF sensor will flood the area with the modulated light, which may produce reflections of the light from many different objects, including objects that are desired or intended targets and those that are not. If the area in which the ToF sensor is situated is a typical working or living environment, the light will be reflected from many objects that are not intended targets, such as floors, walls, ceilings, furniture, and office equipment. An excessive number of reflections from such objects leads to multipath propagation (MPP). Specifically, as an intended target in the area moves farther away from the ToF sensor, the reflections of light off the intended target are corrupted with reflections from the objects that are not intended targets. In some cases, the reflections from the intended target and the other objects that are not intended targets may add up or even cancel each other out, such as if the modulating input signals are 180 degrees out of phase. In either case, the quality of the data provided by the ToF sensor will suffer.

### SUMMARY

A time-of-flight (ToF) sensor for reducing multipath propagation (MPP) is described herein. The ToF sensor can include a light source configured to emit modulated light in a monitoring area and a projector optically coupled to the light source. The projector can be configured to receive the modulated light and to project the modulated light in the monitoring area. The ToF sensor can also include a processor that can be communicatively coupled to the projector. The processor can be configured to receive tracking data from one or more sensors of a passive tracking system. The tracking data can be associated with an original object in the monitoring area being passively tracked by the passive tracking system, and the monitoring area can include one or more high-interest vicinities and low-interest vicinities. The original object may occupy at least one of the high-interest vicinities and may be outside the low-interest vicinities. The processor can be further configured to, based on the tracking data, signal the projector to selectively spatially control the modulated light in the monitoring area by reducing the amount of modulated light reaching the low-interest vicinities of the monitoring area while the original object occupies the high-interest vicinity.

The projector can include a homogenizing lens system optically coupled to the light source, a spatial light modulator (SLM) optically coupled to the homogenizing lens system, and an objective lens system optically coupled to the SLM. The homogenizing lens system may be configured to provide a uniform pattern of illumination with respect to the modulated light for the SLM. The SLM may be configured to reduce the amount of modulated light reaching the low-interest vicinities of the monitoring area by selectively blocking the modulated light prior to the modulated light reaching the objective lens. The objective lens may be configured to project the modulated light that is not blocked by the SLM. The SLM can be further configured to selectively block the modulated light by directing at least a portion of the modulated light to a light dump or by absorbing at least a portion of the modulated light.

The ToF sensor can also include an imaging sensor configured to receive reflections of the modulated light. The processor can be communicatively coupled to the imaging sensor and can be further configured to determine a depth distance of the original object based on data generated from the received reflections of the modulated light.

In one arrangement, the high-interest vicinity occupied by the original object can be an original high-interest vicinity. The processor can be further configured to, as part of receiving tracking data from the sensors of the passive-tracking system, receive tracking data associated with the original object indicating that the original object has moved from the original high-interest vicinity. The processor can be configured to determine, in response to the original object moving from the original high-interest vicinity, that the original high-interest vicinity is a new low-interest vicinity unoccupied by the original object. The processor can be further configured to, as part of signaling the projector to selectively spatially control the modulated light in the monitoring area, signal the projector to selectively spatially control the modulated light in the monitoring area by reducing the amount of modulated light reaching the new low-interest vicinity.

The processor may also be configured to, as part of receiving tracking data from the sensors of the passive-tracking system, receive tracking data associated with the original object indicating that the original object has moved to occupy a low-interest vicinity and determine that the low-interest vicinity occupied by the original object is a new high-interest vicinity. The processor may be configured to, in response to the determination, signal the projector to cease the reduction of modulated light with respect to the new high-interest vicinity.

As an example, the ToF sensor can be part of the passive tracking system, and the one or more sensors of the passive tracking system may include the ToF sensor, a visible-light sensor, a thermal sensor, or a sonar device. In another example, the original object can be a human. The processor can be further configured to receive tracking data from the sensors that can indicate the lack of presence of the human and in response to the lack of presence of the human, signal the projector to cease selectively spatially controlling the modulated light in the monitoring area.

The processor can be further configured to receive from the sensors tracking data associated with a new object in the monitoring area being passively tracked by the passive tracking system at the same time as the original object. The new object may occupy at least one of the high-interest vicinities and can be outside the low-interest vicinities. The processor can be further configured to, based on the tracking data associated with the original object and the new object, signal the projector to selectively spatially control the modulated light in the monitoring area by reducing the amount of modulated light reaching the low-interest vicinities of the monitoring area while both the original object and the new object occupy the high-interest vicinities.

A method for reducing MPP is described herein. The method can include the steps of diffusively emitting modulated light in a monitoring area for the purpose of determining depth distances, determining that an object is present in the monitoring area, and in response to determining that the object is present, passively tracking the object. The method can also include the steps of identifying a vicinity occupied by the object as a high-interest vicinity and vicinities unoccupied by the object as low-interest vicinities and maintaining the diffusive emission of the modulated light with respect to the high-interest vicinity. Simultaneous to maintaining the diffusive emission of the modulated light with respect to the high-interest vicinity, the diffusive emission of the modulated light with respect to the low-interest vicinities can be ceased such that the amount of modulated light reaching the low-interest vicinities is reduced. A depth distance of the object can also be determined.

Ceasing the diffusive emission of the modulated light with respect to the low-interest vicinities such that the amount of modulated light reaching the low-interest vicinities is reduced can include blocking the modulated light by directing at least a portion of the modulated light to a light dump or by absorbing at least a portion of the modulated light. The method can further include the steps of determining that the depth distance of the object is equal to or greater than a predetermined distance threshold and in response, increasing the intensity of the diffusively emitted modulated light maintained with respect to the high-interest vicinity.

The method can further include the steps of determining that the object is occupying a low-interest vicinity and identifying the low-interest vicinity as a new high-interest vicinity and the previous high-interest vicinity as a new low-interest vicinity based on the object no longer occupying the previous high-interest vicinity. In response to identifying the new high-interest vicinity, the diffusive emission of the modulated light with respect to the new high-interest vicinity can be established. In response to identifying the previous high-interest vicinity as a new low-interest vicinity, the diffusive emission of the modulated light with respect to the new low-interest vicinity can be ceased such that the amount of modulated light reaching the new low-interest vicinity is reduced.

The method can also include the steps of determining that a new object is present in the monitoring area at the same time as the original object and identifying a low-interest vicinity occupied by the new object as a new high-interest vicinity and vicinities unoccupied by both the new object and the original object as low-interest vicinities. The diffusive emission of the modulated light can be maintained with respect to the high-interest vicinity associated with the original object, and the diffusive emission of the modulated light can be established with respect to the new high-interest vicinity associated with the new object. Simultaneous to maintaining the diffusive emission of the modulated light with respect to the high-interest vicinity associated with the original object and establishing the diffusive emission of the modulated light with respect to the new high-interest vicinity associated with the new object, the diffusive emission of the modulated light can be ceased with respect to the low-interest vicinities unoccupied by both the new object and the original objects such that the amount of modulated light reaching the low-interest vicinities is reduced. A depth distance of the new object can also be determined. The method can also include the steps of determining that the object is no longer present in the monitoring area and in response, establishing the diffusive emission of modulated light in the monitoring area.

A method of reducing the effects of MPP arising from the operation of a ToF sensor is also described herein. The method can include the steps of diffusively emitting from the ToF sensor modulated light in a monitoring area, receiving tracking data associated with an object in the monitoring area, and analyzing the tracking data to identify low-interest vicinities of the monitoring area. A low-interest vicinity may be a vicinity of the monitoring area unoccupied by the object. In response to the identification of the low-interest vicinities, the diffusive emission of the modulated light can be transitioned to a spatially controlled emission of the modulated light by preventing the modulated light from being directed to the low-interest vicinities. The method can also include the steps of receiving reflections of the modulated light from the object and based on the received reflections, providing a depth distance of the object in the monitoring area.

The method can further include the steps of analyzing the tracking data to identify a high-interest vicinity of the monitoring area in which the high-interest vicinity is a vicinity of the monitoring area occupied by the object and maintaining the diffusive emission of modulated light with respect to the high-interest vicinity. The method can also include the steps of determining that the object is no longer present in the monitoring area and in response, transitioning back to the diffusive emission of the modulated light such that the spatially controlled emission of the modulated light is stopped.

### BRIEF DESCRIPTION OF THE DRAWINGS

FIG. 1 illustrates an example of a passive-tracking system for passively tracking one or more objects.

FIG. 2 illustrates a block diagram of an example of a passive-tracking system for passively tracking one or more objects.

FIG. 3A illustrates an example of a passive-tracking system with a field-of-view.

FIG. 3B illustrates an example of a coordinate system with respect to a passive-tracking system.

FIG. 3C illustrates an example of an adjusted coordinate system with respect to a passive-tracking system.

FIG. 4 illustrates a block diagram of an example of a ToF sensor.

FIG. 5 illustrates an example of a monitoring area with a human object located therein.

FIG. 6 illustrates an example of a monitoring area with two human objects located therein.

For purposes of simplicity and clarity of illustration, elements shown in the above figures have not necessarily been drawn to scale. For example, the dimensions of some of the elements may be exaggerated relative to other elements for clarity. Further, where considered appropriate, reference numbers may be repeated among the figures to indicate corresponding, analogous, or similar features. In addition, numerous specific details are set forth to provide a thorough understanding of the embodiments described herein. Those of ordinary skill in the art, however, will understand that the embodiments described herein may be practiced without these specific details.

### DETAILED DESCRIPTION

As previously explained, a ToF sensor is designed to emit modulated light to help determine a distance between the ToF sensor and an object. Current ToF sensors, however, suffer from performance problems arising from multipath propagation (MPP). In particular, the effects of MPP may cause the ToF sensor to generate inaccurate distance readings.

To address this problem, a system and method for reducing MPP in a ToF sensor is described herein. Modulated light may be diffusively emitted in a monitoring area for the purpose of determining depth distances. If an object is present, the object can be passively tracked. A vicinity occupied by the object may be identified as a high-interest vicinity, and vicinities unoccupied by the object may be designated as low-interest vicinities. The diffusive emission of the modulated light may be maintained with respect to the high-interest vicinity. Simultaneous to maintaining the diffusive emission of the modulated light with respect to the high-interest vicinity, the diffusive emission of the modulated light with respect to the low-interest vicinities may be ceased such that the amount of modulated light reaching the low-interest vicinities is reduced. A depth distance of the object may be determined.

In view of this arrangement, a ToF sensor can direct light away from unimportant sections of a monitoring area, thereby reducing extraneous reflections of modulated light that may lead to erroneous depth readings. This improvement can be accomplished without incurring excessive expenses, taxing current power limits, or harming living objects that may be passively tracked.

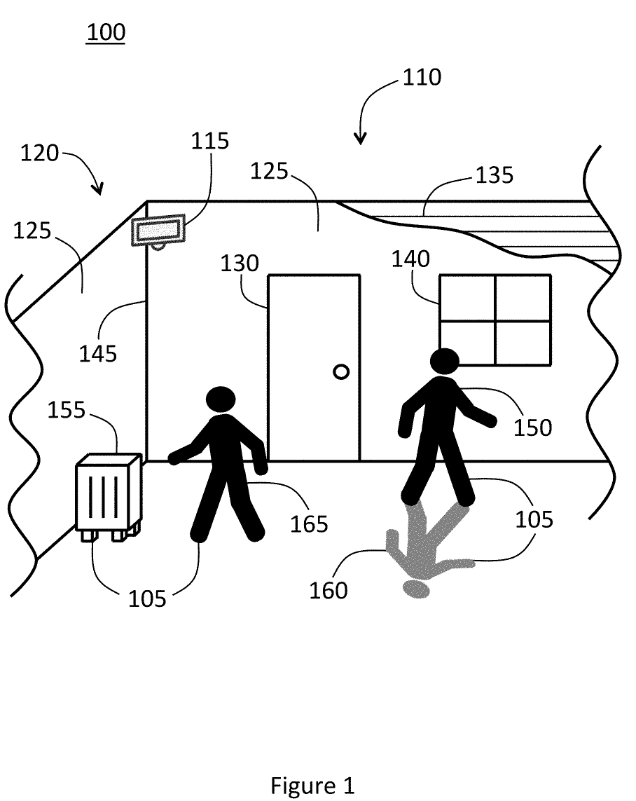

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. Those of skill in the art, however, will understand that the embodiments described herein can be practiced without these specific details.

Several definitions that are applicable here will now be presented. The term “sensor” is defined as a component or a group of components that include at least some circuitry and are sensitive to one or more stimuli that are capable of being generated by or reflected off or originating from a living being, composition, machine, etc. or are otherwise sensitive to variations in one or more phenomena associated with such living being, composition, machine, etc. and provide some signal or output that is proportional or related to the stimuli or the variations. An “object” is defined as any real-world, physical object or one or more phenomena that results from or exists because of the physical object, which may or may not have mass. An example of an object with no mass is a human shadow.

The term “monitoring area” is an area or portion of an area, whether indoors, outdoors, or both, that is the actual or intended target of observation or monitoring for one or more sensors. The term “vicinity” is defined as a portion of a monitoring area. A vicinity can be defined by an area (i.e., two dimensional) or a volume (i.e., three dimensional). The term “high-interest vicinity” is defined as a vicinity that is occupied, whether wholly or partly, by an object that is being or about to be passively tracked or is a candidate for passive tracking. A “low-interest vicinity” is defined as a vicinity that is unoccupied by an object that is being or about to be passively tracked or is a candidate for passive tracking.

A “light source” is defined as a component that emits light, where the emission results from electrical power or a chemical reaction (or both). A “spatial light modulator” is defined as an optical element that dynamically imposes some form of control on light received from a light source by (selectively) interrupting at least some portion of the normal path of the light. The term “modulate” and variations thereof are defined as varying one or more properties of one or more electromagnetic waves to affect the waves in some predetermined manner. A “projector” is defined as a device that is configured to project beams of light, whether in a controlled, arbitrary, or random manner. The term “reduce” and variations thereof are defined as to lower or bring down, such as an amount or intensity of something, and includes a complete or substantial elimination.

A “frame” is defined as a set or collection of data that is produced or provided by one or more sensors or other components. As an example, a frame may be part of a series of successive frames that are separate and discrete transmissions of such data in accordance with a predetermined frame rate. A “reference frame” is defined as a frame that serves as a basis for comparison to another frame. A “visible-light frame” is defined as a frame that at least includes data that is associated with the interaction of visible light with an object or the presence of visible light in a monitoring area or other location. A “sound frame” or a “sound-positioning frame” is defined as a frame that at least includes data that is associated with the interaction of sound with an object or the presence of sound in a monitoring area or other location. A “temperature frame” or a “thermal frame” is defined as a frame that at least includes data that is associated with thermal radiation emitted from an object or the presence of thermal radiation in a monitoring area or other location. A “positioning frame” or a “modulated-light frame” is defined as a frame that at least includes data that is associated with the interaction of modulated light with an object or the presence of modulated light in a monitoring area or other location. The term “tracking data” is defined as data that at least includes positioning data associated with an object. As an example, tracking data may be part of the set or collection of data that makes up a frame.

A “thermal sensor” is defined as a sensor that is sensitive to at least thermal radiation or variations in thermal radiation emitted from an object. A “time-of-flight sensor” is defined as a sensor that emits modulated light and is sensitive to at least reflections of the modulated light from an object. A “visible-light sensor” is defined as a sensor that is sensitive to at least visible light that is reflected off or emitted from an object. A “transducer” is defined as a device that is configured to at least receive one type of energy and convert it into a signal in another form. A “sonar device” is defined as a set of one or more transducers, whether such set of transducers is configured for phased-array operation or not. A “processor” is defined as a circuit-based component or group of circuit-based components that are configured to execute instructions or are programmed with instructions for execution (or both), and examples include single and multi-core processors and co-processors. A “pressure sensor” is defined as a sensor that is sensitive to at least variations in pressure in some medium. Examples of a medium include air or any other gas (or gases) or liquid. The pressure sensor may be configured to detect changes in other phenomena.

The term “circuit-based memory element” is defined as a memory structure that includes at least some circuitry (possibly along with supporting software or file systems for operation) and is configured to store data, whether temporarily or persistently. A “communication circuit” is defined as a circuit that is configured to support or facilitate the transmission of data from one component to another through one or more media, the receipt of data by one component from another through one or more media, or both. As an example, a communication circuit may support or facilitate wired or wireless communications or a combination of both, in accordance with any number and type of communications protocols.

The term “communicatively coupled” is defined as a state in which signals may be exchanged between or among different circuit-based components, either on a uni-directional or bi-directional basis, and includes direct or indirect connections, including wired or wireless connections. The term “optically coupled” is defined as a state, condition, or configuration in which light may be exchanged between or among different circuit-based components, either on a uni-directional or bi-directional basis, and includes direct or indirect connections, including wired or wireless connections.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). Additional definitions may appear below.

Referring to FIG. 1, an example of a system 100 for tracking one or more objects 105 in a monitoring area 110 is shown. In one arrangement, the system 100 may include one or more passive-tracking systems 115, which may be configured to passively track any number of the objects 105. The term “passive-tracking system” is defined as a system that is capable of passively tracking an object. The term “passively track” or “passively tracking” is defined as a process in which a position of an object, over some time, is monitored, observed, recorded, traced, extrapolated, followed, plotted, or otherwise provided (whether the object moves or is stationary) without at least the object being required to carry, support, or use a device capable of exchanging signals with another device that are used to assist in determining the object's position. In some cases, an object that is passively tracked may not be required to take any active step or non-natural action to enable the position of the object to be determined. Examples of such active steps or non-natural actions include the object performing gestures, providing biometric samples, or voicing or broadcasting certain predetermined audible commands or responses. In this manner, an object may be tracked without the object acting outside its ordinary course of action for a particular environment or setting. For purposes of this description, passive tracking may include tracking an object such that one, two, or three positional coordinates of the object are determined and updated over time (if necessary). For example, passive tracking may include a process in which only two positional coordinates of an object are determined and updated.

In one case, the object 105 may be a living being. Examples of living beings include humans and animals (such as pets, service animals, animals that are part of an exhibition, etc.). Although plants are not capable of movement on their own, a plant may be a living being that is tracked or monitored by the system described herein, particularly if they have some significant value and may be vulnerable to theft or vandalism. An object 105 may also be a non-living entity, such as a machine or a physical structure, like a wall or ceiling. As another example, the object 105 may be a phenomenon that is generated by or otherwise exists because of a living being or a non-living entity, such as a shadow, disturbance in a medium (e.g., a wave, ripple or wake in a liquid), vapor, or emitted energy (like heat or light).

The monitoring area 110 may be an enclosed or partially enclosed space, an open setting, or any combination thereof. Examples include man-made structures, like a room, hallway, vehicle or other form of mechanized transportation, porch, open court, roof, pool or other artificial structure for holding water of some other liquid, holding cells, or greenhouses. Examples also include natural settings, like a field, natural bodies of water, nature or animal preserves, forests, hills or mountains, or caves. Examples also include combinations of both man-made structures and natural elements.

In the example here, the monitoring area 110 is an enclosed room 120 (shown in cut-away form) that has a number of walls 125, an entrance 130, a ceiling 135 (also shown in cut-away form), and one or more windows 140, which may permit natural light to enter the room 120. Although coined as an entryway, the entrance 130 may be an exit or some other means of ingress and/or egress for the room 120. In one embodiment, the entrance 130 may provide access (directly or indirectly) to another monitoring area 110, such as an adjoining room or one connected by a hallway. In such a case, the entrance 130 may also be referred to as a portal, particularly for a logical mapping scheme. In another embodiment, the passive-tracking system 115 may be positioned in a corner 145 of the room 120 or in any other suitable location. These parts of the room 120 may also be considered objects 105.

As will be explained below, the passive-tracking system 115 may be configured to passively track any number of objects 105 in the room 120, including both stationary and moving objects 105. In this example, one of the objects 105 in the room 120 is a human 150, another is a portable heater 155, and yet another is a shadow 160 of the human 150. The shadow 160 may be caused by natural light entering the room through the window 140. A second human 165 may also be present in the room 120. Examples of how the passive-tracking system 115 can distinguish the human 150 from the portable heater 155, the shadow 160, and the second human 165 and passively track the human 150 (and the second human 165) can be found in U.S. patent application Ser. No. 15/359,525, filed on Nov. 22, 2016, which is herein incorporated by reference.

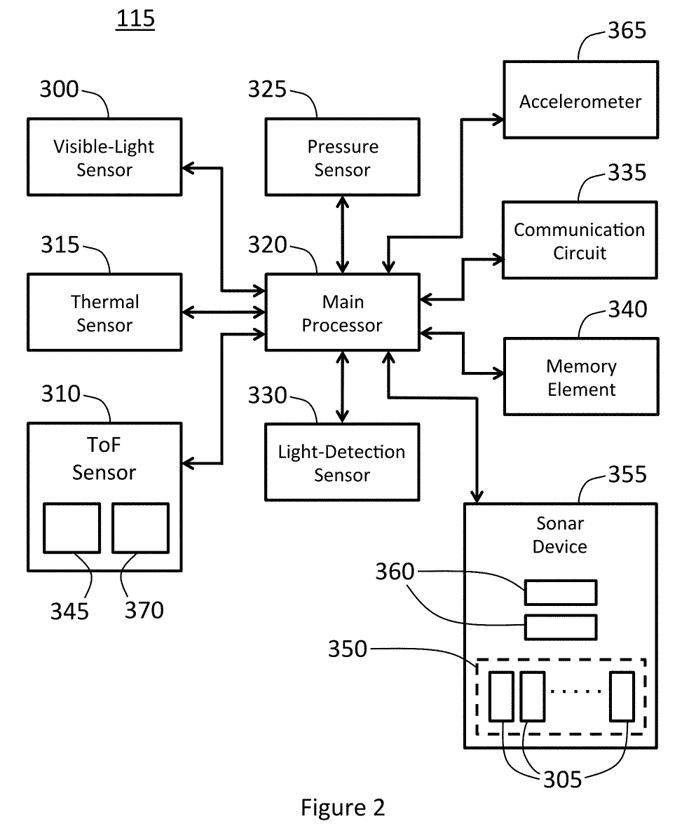

Referring to FIG. 2, a block diagram of an example of a passive-tracking system 115 is shown. In this embodiment, the passive-tracking system 115 can include one or more visible-light sensors 300, one or more sound transducers 305, one or more time-of-flight (ToF) sensors 310, one or more thermal sensors 315, and one or more main processors 320. The passive-tracking system 115 may also include one or more pressure sensors 325, one or more light-detection sensors 330, one or more communication circuits 335, and one or more circuit-based memory elements 340. Each of the foregoing devices can be communicatively coupled to the main processor 320 and to each other, where necessary. Although not pictured here, the passive-tracking system 115 may also include other components to facilitate its operation, like power supplies (portable or fixed), heat sinks, displays or other visual indicators (like LEDs), speakers, and supporting circuitry.

In one arrangement, the visible-light sensor 300 can be a visible-light camera that is capable of generating images or frames based on visible light that is reflected off any number of objects 105. These visible-light frames may also be based on visible light emitted from the objects 105 or a combination of visible light emitted from and reflected off the objects 105. In this description, the non-visible light may also contribute to the data of the visible-light frames, if such a configuration is desired. The rate at which the visible-light sensor 300 generates the visible-light frames may be periodic at regular or irregular intervals (or a combination of both) and may be based on one or more time periods. In addition, the rate may also be set based on a predetermined event (including a condition), such as adjusting the rate in view of certain lighting conditions or variations in equipment. The visible-light sensor 300 may also be capable of generating visible-light frames based on any suitable resolution and in full color or monochrome. In one embodiment, the visible-light sensor 300 may be equipped with an IR filter (not shown), making it responsive to only visible light. As an alternative, the visible-light sensor 300 may not be equipped with the IR filter, which can enable the sensor 300 to be sensitive to IR light.

The sound transducer 305 may be configured to at least receive soundwaves and convert them into electrical signals for processing. As an example, the passive-tracking system 115 can include an array 350 of sound transducers 305, which can make up part of a sonar device 355. The sonar device 355 may be referred to as a sensor of the passive-tracking system 115, even though it may be comprised of various discrete components, including at least some of these described here. As another example, the sonar device 355 can include one or more sound transmitters 360 configured to transmit, for example, ultrasonic sound waves in at least the monitored area 110. That is, the array 350 of sound transducers 305 may be integrated with the sound transmitters 360 as part of the sonar device 355. The sound transducers 305 can capture and process the sound waves that are reflected off the objects 105.

In one embodiment, the sound transducers 305 and the sound transmitters 360 may be physically separate components. In another arrangement, one or more of the sound transducers 305 may be configured to both transmit and receive soundwaves. In this example, the sound transmitters 360 may be part of the sound transducers 305. If the sound transducers 305 and the sound transmitters 360 are separate devices, the sound transducers 305 may be arranged horizontally in the array 350, and the sound transmitters 360 may be positioned vertically in the array 350. This configuration may be reversed, as well. In either case, the horizontal and vertical placements can enable the sonar device 355 to scan in two dimensions. The sound transducers 305 may also be configured to capture speech or other sounds that are audible to humans or other animals, which may originate from sources other than the sound transmitters 360.

The ToF sensor 310 can be configured to emit modulated light in the monitoring area 110 or some other location and to receive reflections of the modulated light off an object 105, which may be within the monitoring area 110 or other location. The ToF sensor 310 can convert the received reflections into electrical signals for processing. As part of this step, the ToF sensor 310 can generate one or more frames of positioning frames or modulated-light frames in which the data of such frames is associated with the reflections of modulated light off the objects 105. This data may also be associated with light from sources other than those that emit modulated-light and/or from sources other than those that are part of the ToF sensor 310. If the ToF sensor 310 is configured with a filter to block out wavelengths of light that are outside the frequency (or frequencies) of its emitted modulated light, the light from these other sources may be within such frequencies. As an example, the ToF sensor 310 can include one or more modulated-light sources 345 and one or more imaging sensors 370, and the phase shift between the illumination and the received reflections can be translated into positional data. As an example, the light emitted from the ToF sensor 310 may have a wavelength that is outside the range for visible light, such as infrared (including near-infrared) light. Additional information about the ToF sensor 310 will be presented below.

The thermal sensor 315 can detect thermal radiation emitted from any number of objects 105 in the monitoring area 110 or some other location and can generate one or more thermal or temperatures frames that include data associated with the thermal radiation from the objects 105. The objects 105 from which the thermal radiation is emitted can be from living beings or from machines, like portable heaters, engines, motors, lights, or other devices that give off heat and/or light. As another example, sunlight (or other light) that enters the monitoring area 110 (or other location) may also be an object 105, as the thermal sensor 315 can detect thermal radiation from this condition or from its interaction with a physical object 105 (like a floor). As an example, the thermal sensor 315 may detect thermal radiation in the medium-wavelength-infrared (MWIR) and/or long-wavelength-infrared (LWIR) bands.

The main processor 320 can oversee the operation of the passive-tracking system 115 and can coordinate processes between all or any number of the components (including the different sensors) of the system 115. Any suitable architecture or design may be used for the main processor 320. For example, the main processor 320 may be implemented with one or more general-purpose and/or one or more special-purpose processors, either of which may include single-core or multi-core architectures. Examples of suitable processors include microprocessors, microcontrollers, digital signal processors (DSP), and other circuitry that can execute software or cause it to be executed (or any combination of the foregoing). Further examples of suitable processors include, but are not limited to, a central processing unit (CPU), an array processor, a vector processor, a field-programmable gate array (FPGA), a programmable logic array (PLA), an application specific integrated circuit (ASIC), and programmable logic circuitry. The main processor 320 can include at least one hardware circuit (e.g., an integrated circuit) configured to carry out instructions contained in program code.

In arrangements in which there is a plurality of main processors 320, such processors 320 can work independently from each other or one or more processors 320 can work in combination with each other. In one or more arrangements, the main processor 320 can be a main processor of some other device, of which the passive-tracking system 115 may or may not be a part. This description about processors may apply to any other processor that may be part of any system or component described herein, including any of the individual sensors or other components of the passive-tracking system 115. That is, any one of the sensors of the passive-tracking system 115 can have one or more processors similar to the main processor 320 described here.

The pressure sensor 325 can detect pressure variations or disturbances in virtually any type of medium, such as air or liquid. As an example, the pressure sensor 325 can be an air pressure sensor that can detect changes in air pressure in the monitored area 110 (or some other location), which may be indicative of an object 105 entering or otherwise being in the monitored area 110 (or other location). For example, if a human passes through an opening (or portal) to a monitored area 110, a pressure disturbance in the air of the monitored area 110 is detected by the pressure sensor 325, which can then lead to some other component taking a particular action.

The pressure sensor 325 may be part of the passive-tracking system 115, or it may be integrated with another device, which may or may not be positioned within the monitoring area 110. For example, the pressure sensor 325 may be a switch that generates a signal when a door or window that provides ingress/egress to the monitoring area 110 is opened, either partially or completely. Moreover, the pressure sensor 325 may be configured to detect other disturbances, like changes in an electro-magnetic field or the interruption of a beam of light (i.e., visible or non-visible). As an option, no matter what event may trigger a response in the pressure sensor 325, a minimum threshold may be set (and adjusted) to provide a balance between ignoring minor variations that would most likely not be reflective of an object 105 that warrants passive tracking entering the monitoring area 110 (or other location) and processing disturbances that most likely would be. In addition to acting as a trigger for other sensors or components of the passive-tracking system 115, the pressure sensor 325 may also generate one or more pressure frames, which can include data based on, for example, pressure variations caused by or originating from an object 105.

The light-detection circuit 330 can detect an amount of light in the monitoring area 110 (or other location), and this light may be from any number and type of sources, such as natural light, permanent or portable lighting fixtures, portable computing devices, flashlights, fires (including from controlled or uncontrolled burning), or headlights. Based on the amount of light detected by the light-detection circuit 330, one or more of the other devices of the passive-tracking system 115 may be activated or deactivated, examples of which will be provided later. Like the pressure sensor 325, the light-detection circuit 330 can be a part of the passive-tracking system 115 or some other device. In addition, minimum and maximum thresholds may be set (and adjusted) for the light-detection circuit 330 for determining which lighting conditions may result in one or more different actions occurring.

The communication circuits 335 can permit the passive-tracking system 115 to exchange data with other passive-tracking systems 115, a hub, or any other device, system, or network. To support various type of communication, including those governed by certain protocols or standards, the passive-tracking system 115 can include any number and kind of communication circuits 335. For example, communication circuits 335 that support wired or wireless (or both) communications may be used here, including for both local- and wide-area communications. Examples of protocols or standards under which the communications circuits 335 may operate include Bluetooth, Near Field Communication, and Wi-Fi, although virtually any other specification for governing communications between or among devices and networks may govern the communications of the passive-tracking system 115. Although the communication circuits 335 may support bi-directional exchanges between the system 115 and other devices, one or more (or even all) of such circuits 335 may be designed to only support unidirectional communications, such as only receiving or only transmitting signals.

The circuit-based memory elements 340 can be include any number of units and type of memory for storing data. As an example, a circuit-based memory element 340 may store instructions and other programs to enable any of the components, devices, sensors, and systems of the passive-tracking system 115 to perform their functions. As an example, a circuit-based memory element 340 can include volatile and/or non-volatile memory. Examples of suitable data stores here include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. A circuit-based memory element 340 can be part of the main processor 320 or can be communicatively connected to the main processor 320 (and any other suitable devices) for use thereby. In addition, any of the various sensors and other parts of the passive-tracking system 115 may include one or more circuit-based memory elements 340.

The passive-tracking system 115 is not necessarily limited to the foregoing design, as it may not necessarily include each of the previously listed components. Moreover, the passive-tracking system 115 may include components beyond those described above. For example, instead of or in addition to the sonar device 355, the system 115 can include a radar array, such as a frequency-modulated, continuous-wave (FMCW) system, that emits a sequence of continuous (non-pulsed) signals at different frequencies, which can be linearly spaced through the relevant spectrum. The results, which include the amplitude and phase of the reflected waves, may be passed through a Fourier transform to recover, for example, spatial information of an object 105. One example of such spatial information is a distance of the object 105 from the array. In some FMCW systems, the distances wrap or otherwise repeat—a discrete input to a Fourier transform produces a periodic output signal—and a tradeoff may be necessary between the maximum range and the number of frequencies used.

Some or all of the various components (e.g., sensors) of the passive-tracking system 115 may be oriented in a particular direction. These orientations may be fixed, although they may also be adjusted if necessary. As part of the operation of the passive-tracking system 115, some of the outputs of the different components of the system 115 may be compared or mapped against those of one or more other components of the system 115. To accommodate such an arrangement, the orientations of one or more components of the passive-tracking system 115 may be set so that they overlap one another.

A particular sensor of the passive-tracking system 115 may have a field-of-view (FoV), which may define the boundaries of an area that are within a range of operation for that sensor. As an example, the visible-light sensor 300, depending on its structure and orientation, may be able to capture image data of every part of a monitoring area 110 or only portions of the area 110. The FoV for one or more of the other components of the passive-tracking system 115 may be substantially aligned with the FoV of the visible-light sensor 300. For example, the FoV for the array 350 of sound transducers 305, ToF sensor 310, thermal sensor 315, and pressure sensor 325 may be effectively matched to that of the visible-light sensor 300. As part of this arrangement, the FoV for one particular component of the passive-tracking system 115 may be more expansive or narrower in comparison to that of another component of the passive-tracking system 115, although at least some part of their FoVs may be aligned. This alignment process can enable data from one or more of the sensors of the passive-tracking system 115 to be compared and merged or otherwise correlated with data from one or more other sensors of the system 115. Some benefits to this arrangement include the possibility of using a common coordinate or positional system among different sensors and confirmation of certain readings or other data from a particular sensor.

If desired, the orientation of the passive-tracking system 115 (as a whole) may be adjusted, either locally or remotely, and may be moved continuously or periodically according to one or more intervals. In addition, the orientations of one or more of the sensors (or other components) of the passive-tracking system 115 may be adjusted or moved in a similar fashion, either individually (or independently) or synchronously with other sensors or components. Any changes in orientation may be done while maintaining the alignments of one or more of the FoVs, or the alignments may be dropped or altered. Optionally, the system 115 or any component thereof may include one or more accelerometers 365, which can determine the positioning or orientation of the system 115 overall or any particular sensor or component that is part of the system 115. The accelerometer 365 may provide, for example, attitude information with respect to the system 115.

As presented as an earlier example, a passive-tracking system 115 may be assigned to a monitoring area 110 (or some other location), which may be a room 120 that has walls 125, an entrance 130, a ceiling 135, and windows 140 (see FIG. 1). Any number of objects 105 may be in the room 120 at any particular time, such as the human 150, the portable heater 155, and the shadow 160. As also noted above, many of the sensors of the passive-tracking system 115 may generate one or more frames, which may include data associated with, for example, the monitoring area 110, in this case, the room 120. For example, the visible-light sensor 300 may generate at any particular rate one or more visible-light frames that include visible-light data associated with the room 120. As part of this process, visible light that is reflected off one or more objects 105 of the room 120, like the walls 125, entrance 130, ceiling 135, windows 140, and heater 155, can be captured by the visible-light sensor 300 and processed into the data of the visible-light frames. In addition, as pointed out earlier, the visible light that is captured by the visible-light sensor 300 may be emitted from an object 105, and this light may affect the content of the visible-light frames.

In one arrangement, one or more of these visible-light frames may be set as visible-light reference frames, to which other visible-light frames may be compared. For example, in an initial phase of operation, the visible-light sensor 300 may capture images of the room 120 and can generate the visible-light frames, which may contain data about the layout of the room 120 and certain objects 105 in the room 120 that are present during this initial phase. Some of the objects 105 may be permanent fixtures of the room 120, such as the walls 125, entrance 130, ceiling 135, windows 140, and heater 155 (if the heater 155 is left in the room 120 for an extended period of time). As such, these initial visible-light frames can be set as visible-light reference frames and can be stored in, for example, the circuit-based memory element 340 or some other database for later retrieval. Because these objects 105 may be considered permanent or recognized fixtures of the room 120, as an option, a decision can be made that passively tracking such objects 105 is unnecessary or not helpful. Other objects 105, not just permanent or recognized fixtures of the room 120, may also be ignored for purposes of passively tracking.

As such, because these insignificant objects 105 may not be passively tracked, they can be used to narrow the focus of the passive-tracking process. For example, assume one or more visible-light reference frames include data associated with one or more objects 105 that are not to be passively tracked. When the visible-light sensor 300 generates a current visible-light frame and forwards it to the main processor 320, the main processor 320 may retrieve the visible-light reference frame and compare it to the current visible-light frame. As part of this comparison, the main processor 320 can ignore the objects 105 in the current frame that are substantially the same size and are in substantially the same position as the objects 105 of the reference frame. The main processor 320 can then focus on new or unidentified objects 105 in the current visible-light frame that do not appear as part of the visible-light reference frame, and they may be suitable candidates for passive tracking. The principles and examples described above may also apply to some of the other components, such as the sonar device 355, the thermal sensor 315, or the ToF sensor 310, of the passive-tracking system 115.

As part of passively tracking objects 105, the main processor 320 can receive and analyze frames from one or more of the sensors of the passive-tracking system 115. Some of this analysis may include the main processor 320 comparing the data of the frames to one or more corresponding reference frames. In one embodiment, following the comparison, some of the data of the frames from the different sensors may be merged for additional analysis or actions. For example, relevant data from the frames generated by the visible-light sensor 300 and the thermal sensor 315 may be combined. Based on this combination, the main processor 320 may determine positional or tracking data associated with an object 105 in the monitoring area 110, and this tracking data may be updated over time. In one embodiment, this tracking data may conform to a known reference system, such as a predetermined coordinate system, with respect to the location of the passive-tracking system 115.

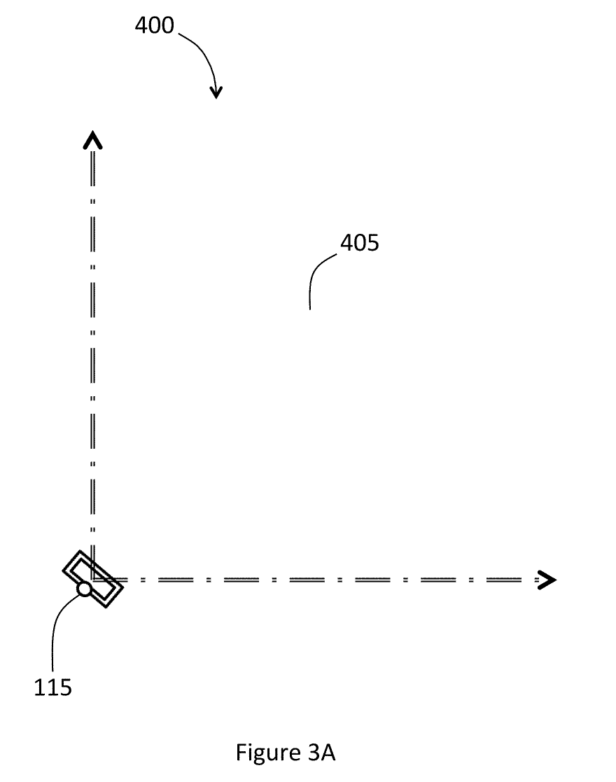

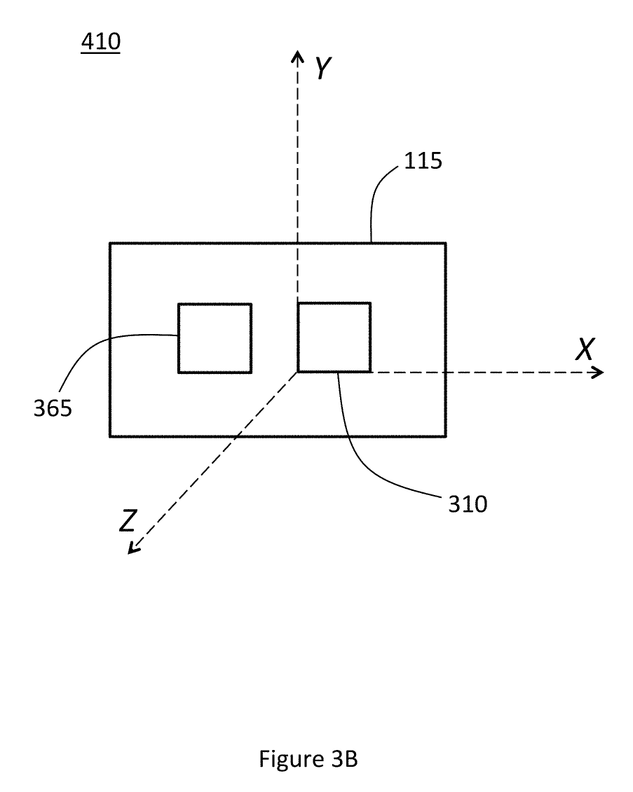

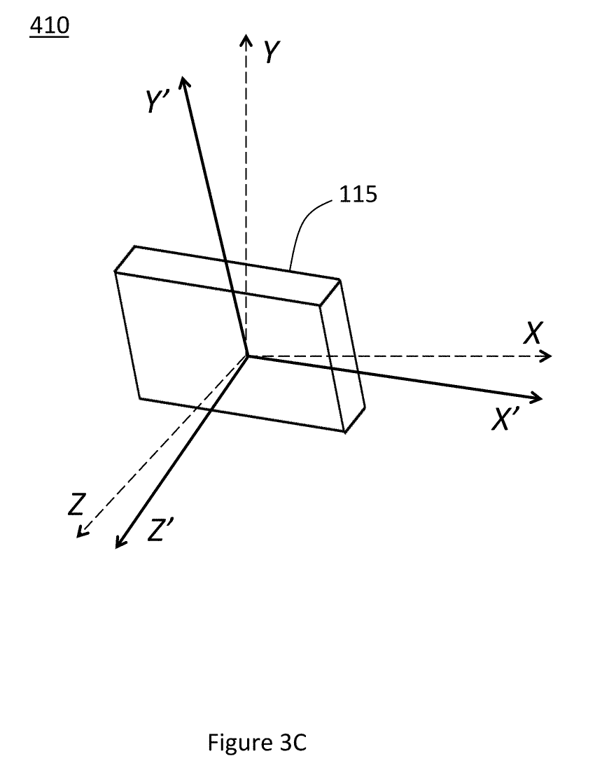

Referring to FIG. 3A, an example of the passive-tracking system 115 in a monitoring area 110 with a field of view (FoV) 400 is shown. In one arrangement, the FoV 400 is the range of operation of a sensor of the passive-tracking system 115. For example, the visible-light sensor 300 may have a FoV 400 in which objects 105 or portions of the objects 105 within the area 405 of the FoV 400 may be detected and processed by the visible-light sensor 300. In addition, the ToF sensor 310 and the thermal sensor 315 may each have a FoV 400. In one arrangement, the FoVs 400 for these different sensors may be effectively merged, meaning that the coverage areas for these FoVs 400 may be roughly the same. As such, the merged FoVs 400 may be considered an aggregate or common FoV 400. Of course, such a feature may not be necessary, but by relying on a common FoV 400, the data from any of the various sensors of the passive-tracking system 115 may be easily correlated with or otherwise mapped against that of any of the other sensors.

As an example, the coverage area of each (individual) FoV 400 may have a shape that is comparable to a pyramid or a cone, with the apex at the relevant sensor. To ensure substantial overlapping of the individual FoVs 400 for purposes of realizing the common FoV 400, the sensors of the passive-tracking system 115 may be positioned close to one another and may be set with similar orientations. As another example, the range of the horizontal component of each (individual) FoV 400 may be approximately 90 degrees, and the common FoV 400 may have a similar horizontal range as a result of the overlapping of the individual FoVs 400. This configuration may provide for full coverage of at least a portion of a monitoring area 110 if the passive-tracking system 115 is positioned in a corner of the area 110. The FoV 400 (common or individual), however, may incorporate other suitable settings or even may be adjusted, depending on, for instance, the configurations of the monitoring area 110.

In one embodiment, the FoV 400 may represent a standard or default range of operation of one or more sensors of the system 115, although the FoV 400 may not necessarily represent or otherwise match the coverage area of emissions of some of the sensors. For example, as will be explained below, the operation of one or more sensors may be adjusted, depending on one or more factors. As a specific example, the FoV 400 may represent the maximum coverage area of the light that the ToF sensor 310 emits in a diffusive manner. Of course, in other embodiments, the coverage area of the light that is diffusively emitted by the ToF sensor 310 may be different from the FoV 400 pictured here. For example, the ToF sensor 310 may be configured to emit light diffusively at an angle that is wider (or narrower) than 90 degrees, and this emitted light may not necessarily assume the shape of a cone. The phrase “diffusively emitting modulated light” is defined as emitting modulated light in accordance with an illumination pattern that substantially matches a preconfigured maximum coverage area for the emitted modulated light, whether that maximum coverage area is set by the operational or physical limits of the device that emits the modulate light or by the structural limits of the area receiving the modulated light.

In some cases, the emitted light may be manipulated or controlled, and this operation may shrink the area that is illuminated by the light. As such, the ToF sensor 310 may transition between a diffusive-emission mode, which may result in the monitoring area 110 being broadly illuminated, and a controlled-emission mode, which may lead to a reduction in the amount of light illuminating the monitoring area 110. Examples of this process will be presented below.

Referring to FIG. 3B, a positional or coordinate system 410 may be defined for the passive-tracking system 115. In one arrangement, the X axis and the Y axis may be defined by the ToF sensor 310, and the Z axis may be based on a direction pointing out the front of the ToF sensor 310 in which the direction is orthogonal to the X and Y axes. In this example, the ToF sensor 310 may be considered a reference sensor. Other sensors of the system 115 or various combinations of such sensors (like the visible-light sensor 300 and the ToF sensor 310) may act as the reference sensor(s) for purposes of defining the X, Y, and Z axes. To achieve consistency in the positional data that originates from the coordinate system 410, the sensors of the system 115 may be pointed or oriented in a direction that is at least substantially similar to that of the reference sensor.

In one arrangement, each of the sensors that provide positional data related to one or more objects may initially generate such data in accordance with a spherical coordinate system (not shown), which may include values for azimuth, elevation, and depth distance. Note that not all sensors may be able to provide all three spherical values. The sensors (or possibly the main processor 320 or some other device) may then convert the spherical values to Cartesian coordinates based on the X, Y, and Z axes of the coordinate system 410. This X, Y, and Z positional data may be associated with one or more objects 105 in the monitoring area 110, with the X data related to the azimuth values, Y data related to the elevation values, and Z data related to the depth-distance values.

In certain circumstances, the orientation of the passive-tracking system 115 may change. For example, the initial X, Y, and Z axes of the system 115 may be defined when the system 115 is placed on a flat surface. If the positioning of the system 115 shifts, however, adjustments to the coordinate system 410 may be necessary. For example, if the system 115 is secured to a higher location in a monitoring area 110, the system 115 may be aimed downward, thereby affecting its pitch. The roll and yaw of the system 115 may also be affected. As will be explained below, the accelerometer 365 may assist in making adjustments to the coordinate system 410.

Referring to FIG. 3C, the passive-tracking system 115 is shown in which at least the pitch and roll of the system 115 have been affected. The yaw of the system 115 may have also been affected. In one arrangement, however, the change in yaw may be assumed to be negligible. The initial X, Y, and Z axes are now labeled as X′, Y′, and Z′ (each in solid lines), and they indicate the shift in the position of the system 115. In one embodiment, the system 115 can define adjusted X, Y, and Z axes, which are labeled as X, Y, and Z (each with dashed lines), and the adjusted axes may be aligned with the initial X, Y, and Z axes of the coordinate system 410.

To define the adjusted X, Y, and Z axes, first assume the adjusted Y axis is a vertical axis passing through the center of the initial X, Y, and Z axes. The accelerometer 365 may provide information (related to gravity) that can be used to define the adjusted Y axis. The remaining adjusted X and Z axes may be assumed to be at right angles to the (defined) adjusted Y axis. In addition, an imaginary plane may pass through the adjusted Y axis and the initial Z axis, and a horizontal axis (with respect to the adjusted Y axis) that lies on this plane may be determined to be the adjusted Z axis. The adjusted X axis is found by identifying the only axis that is orthogonal to both the adjusted Y axis and the adjusted Z axis. One skilled in the art will appreciate that there are other ways to define the adjusted axes.

Once the adjusted X, Y, and Z axes are defined, the initial X, Y, and Z coordinates may be converted into adjusted X, Y, and Z coordinates. That is, if a sensor or some other device produces X, Y, and Z coordinates that are based on the initial X, Y, and Z axes, the system 115 can adjust these initial coordinates to account for the change in the position of the system 115. When referring to (1) a three-dimensional position, (2) X, Y, and Z positional data, (3) X, Y, and Z positions, or (4) X, Y, and Z coordinates, such as in relation to one or more objects 105 being passively tracked, these terms may be defined by the initial X, Y, and Z axes or the adjusted X, Y, and Z axes of the coordinate system 410 (or even both). Moreover, positional data related to an object 105 is not necessarily limited to Cartesian coordinates, as other coordinate systems may be employed, such as a spherical coordinate system. No matter whether initial or adjusted positional data is acquired by a passive-tracking system 115, the system 115 may share such data with other devices.

In accordance with the description above, current frames from the components or sensors of the passive-tracking system 115 may include various positional data, such as different combinations of data associated with the X, Y, and Z positions, related to one or more objects 105. For example, the visible-light sensor 300 and the thermal sensor 310 may provide data related to the X and Y positions of an object 105, and the data from the ToF sensor 310 may relate to the X, Y, and Z positions of the object 105. In some cases, the data about the Z positions provided by the ToF sensor 310 may receive significant attention because it provides depth distance, and the data associated with the X and Y positions from the ToF sensor 310 may either be ignored, filtered out, or used for some other purpose (like tuning or confirming measurements from another sensor). As another example, a sonar device 355 (see FIG. 2) may be useful for determining or confirming X and Z positions of an object 105.

In one arrangement, tracking data from the sensors of the passive-tracking system 115 may be useful for optimizing the operation of the ToF sensor 310. For example, X- and Y-positional data from the visible-light sensor 300 or the thermal sensor 315 (or both) can be used to cause the ToF sensor 310 to reduce the amount of modulated light reaching certain portions of the monitoring area 110. As another example, Z-positional data from the sonar device 355 of the system 115 may be relied on to facilitate a similar operation or to cause other adjustments in the operation of the ToF sensor 310. In some cases, positional data from the ToF sensor 310 itself may be used to manage its operation.

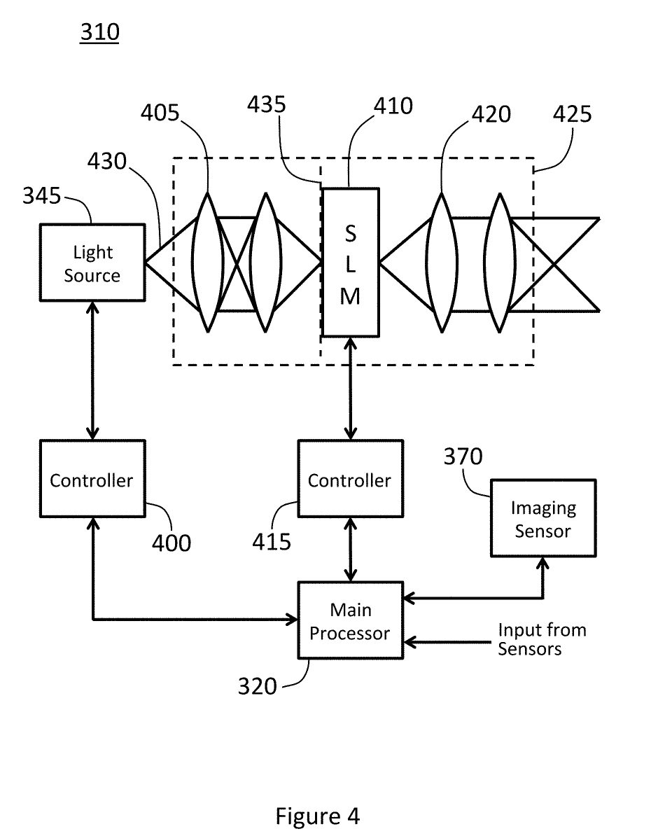

Before presenting examples of such a process, additional information about the ToF sensor 310 will be provided. Referring to FIG. 4, a block diagram that shows a possible configuration of the ToF sensor 310 is illustrated. The ToF sensor 310, as pointed out earlier, can include one or more modulated light sources 345 and one or more detectors or imaging sensors 370. The ToF sensor 310 may also include one or more controllers 400 for controlling the modulated light sources 345, such as by adjusting the power to the light sources 345 to correspondingly modify the intensity of the emitted light.

The ToF sensor 310 can also include one or more homogenizing lens systems 405, one or more spatial light modulators (SLM) 410, one or more controllers 415 for controlling the SLMs, and one or more objective lens systems 420. The homogenizing lens system 405, the SLM 410, the controller 415, and the objective lens system 420 may collectively form a projector 425. The projector 425 may not necessarily include each of these components, or it may include other components that may or may not be described herein. In addition, the main processor 320 may be communicatively coupled to and control the operation of several of the components of the ToF sensor 310, such as the light source 345 (through the controller 400), the homogenizing lens system 405, the SLM 410 (through the controller 415), and the objective lens system 420. The processor 320, as also previously noted, may receive input from the imaging sensor 370 of the ToF sensor 310 and from the other sensors of the passive-tracking system 115, such as the visible-light sensor 300, the thermal sensor 315, and/or the sonar device 355. Although the main processor 320, as presented in this configuration, may be a component separate and distinct from the ToF sensor 310, such an arrangement is not meant to be limiting, as the processor 320 or some other processor may be incorporated into or otherwise be part of the ToF sensor 310.

In accordance with an earlier example, the modulated light source 345 may be a light source that can emit light in the IR range, such as near-IR light. The light source 345, however, can be configured to emit light of other suitable wavelengths, including those of other non-visible light, visible light, or a combination of visible light and non-visible light. As another example, the light source 345 may be one or more lasers, although other illumination sources (such as light-emitting diodes (LED), incandescent lamps, or even those that produce light from a chemical reaction) may be employed.

In one arrangement, the modulated light source 345 may be a laser that is modulated by an input signal, like a continuous-wave source such as a sinusoid or square wave, and emits light output 430, also referred to as modulated light. In some cases, the projector 425 may, under the direction of the main processor 320, selectively spatially control the modulated light. For example, the projector 425 can be configured to selectively block at least a portion of the modulated light prior to the light exiting the ToF sensor 310. Examples of this technique will be presented below. If desired, the main processor 320 may also be configured to adjust the intensity of the modulated light, such as by controlling output power to the light source 345.

In one embodiment, the homogenizing lens system 405 may be optically coupled to the light source 345 and may receive the light output 430. As an example, the homogenizing lens system 405 may be a lens system, although it is not necessarily limited to such a configuration, as other devices could also be used here. The SLM 410 may be optically coupled to the homogenizing lens system 405, and the system 405 may be configured to provide a uniform pattern of illumination at the SLM 410. In one arrangement, the SLM 410 may be placed in a focal plane 435, which can help minimize the effects of light diffraction.

The SLM 410 can be configured to selectively spatially control the modulated light. For example, the SLM 410 may reduce the amount of modulated light reaching certain sections of the monitoring area 110, such as unimportant locations of the area 110. The phrase “selectively spatially control modulated light” is defined as exercising some interrupting influence on at least a portion of modulated light, based on a certain event or condition, to affect the illumination by the modulated light of one or more locations in space. Various types of SLMs 410 may be employed here. For example, the SLM 410 may be a digital micro-mirror device (DMD) in which the DMD's pixels are provided by individually addressable and movable mirrored surfaces of a micro-electro-mechanical system (MEMS). As another example, the SLM 410 may utilize liquid-crystal (LC) technology to carry out the modulation, such as a liquid-crystal display (LCD) SLM or a liquid-crystal-on-silicon (LCoS) display. As is known in the art, SLMs 410 that rely on LC technology are controlled by selectively applying voltage to the electrodes, which creates an electric field in the LC material. A DMD or LC SLM, in view of their architectures, may be dynamically operable, meaning the control that these devices may exert on the modulated light may be programmable or otherwise manageable.

The SLM 410 may be configured to operate in one or more modes. For example, the SLM 410 may operate in a diffusive-emission mode and a controlled-emission mode. In the diffusive-emission mode, the SLM 410 may receive the modulated light and exert little to no control on the modulated light, thereby allowing the light to be diffusively or expansively emitted throughout the monitoring area 110. In one option, the coverage area of the modulated light in the diffusive-emission mode may be substantially equivalent to a maximum coverage area of the ToF sensor 310 with respect to the modulated light. In some cases, the diffusive-emission mode may be a default or conventional style of operation for the ToF sensor 310.

In the controlled-emission mode, the SLM 410 may exert at least some spatial control on the modulated light, including a portion of the light or the light in its entirety. In this mode, the SLM 410 may control the modulated light by reducing the amount of modulated light reaching certain sections of the monitoring area 110. For example, the SLM 410 may be configured to block or interfere with at least some portion of the modulated light prior to its exit from the ToF sensor 310. As a specific example, the SLM 410 may be configured to direct a portion of the modulated light to a light dump (not shown), such as in the case of a DMD SLM. As another specific example, the SLM 410 may be configured to absorb a portion of the modulated light, which may be realized in an LC SLM. No matter how the SLM 410 blocks the modulated light, it may block only a portion of the light or all of it. In addition, the portions of the monitoring area 110 that are affected by this selective control of the modulated light may be based on certain events or conditions in the monitoring area 110, examples of which will be presented below.

In the controlled-emission mode, no matter whether a portion or all of the modulated light is blocked, the blockage may have a transparency setting associated with it. In particular, the blockage may not result in a complete blockage of the modulated light (portion or entirety) that is to be affected by the exerted control. For example, if a portion of the modulated light is to be spatially controlled such that this portion is to be blocked by the SLM 410, the SLM 410 may be configured to maintain a certain degree of transparency to permit at least some of the modulated light to be blocked to pass through. In such a case, the amount of modulated light reaching certain sections of the monitoring area 110 may be reduced, although not completely eliminated, by some percentage. If the modulated light is to be blocked in its entirety, a transparency setting may be applied to allow at least some percentage of the light to pass through, if desired. Some examples of SLMs that enable this operation include LCDs and some LCoS panels, such as those that allow analog amplitude modulation of the light, sometimes called an analog backplane. As can be seen, by applying a transparency setting to the modulated light, either a portion of it or its entirety, the overall intensity of the light may be controlled.

The portion of the modulated light that is unaffected by the spatial control exerted by the SLM 410 may effectively remain in its original form. As such, because the input signal of the (unaffected) modulated light is not disturbed, the ability of the ToF sensor 310 to determine depth distances should be maintained. Moreover, if the SLM 410 only controls some portion of the modulated light, the part of the modulated light that is unaffected by such control may still be considered a diffusive emission of modulated light with respect to the sections of the monitoring area 110 that receive the unaffected modulated light. At the control of the main processor 320, the SLM 410 may also shift between the diffusive- and controlled-emission modes.

Modulated light that exits the SLM 410 may be received by the objective lens system 420, which can project the modulated light that is not blocked by the SLM 410. No matter the intensity or amount of modulated light that is emitted, at least some of the modulated light may be reflected back to the imaging sensor 370 of the ToF sensor 310. The imaging sensor 370 may then convert the captured reflections into raw data that it can feed to the main processor 320. The main processor 320, based on this raw data, may then generate positional or tracking data associated with the object 105. The tracking data may include, for example, X, Y, and Z coordinates, with the Z coordinate arising from a depth distance for the object 105 with respect to the ToF sensor 310.

In one arrangement, the main processor 320 may receive the frames that are generated by the other sensors of the passive-tracking system 115, such as the visible-light sensor 300, the thermal sensor 315, the sonar device 355, or any combination thereof. For example, the visible-light sensor 300 and the thermal sensor 315 may generate frames that include data about one or more objects 105 in the monitoring area 110. The main processor 320 may receive and analyze these frames to determine whether any of the objects 105 are suitable for passive tracking. As an example, an object 105 that is human may be suitable for passive tracking. Objects 105 that are suitable for passive tracking may be referred to as candidates for passive tracking.

Continuing with the example, tracking data about the objects 105 detected by the visible-light sensor 300 and the thermal sensor 315 may form part of the data of the frames generated by these sensors. The processor 320 may extract and further process the tracking data to determine positional coordinates associated with the objects 105. In one arrangement, the processor 320 may determine the positional coordinates only for the objects 105 that have been identified as suitable for passive tracking (or are otherwise already being passively tracked). In the case of the frames from the visible-light sensor 300 and the thermal sensor 315, the positional coordinates may be X and Y coordinates associated with the objects 105 that have been designated as being suitable for passive tracking.

Positional coordinates may be acquired from tracking data generated by other sensors of the passive-tracking system 115. For example, main processor 320 may determine X and Z coordinates from the frames produced by the sonar device 355. Similar positional data may be obtained from frames generated by a radar unit. As another example, positional data may be received from different passive-tracking systems 115 or other devices or systems that may be remote to the instant passive-tracking system 115.

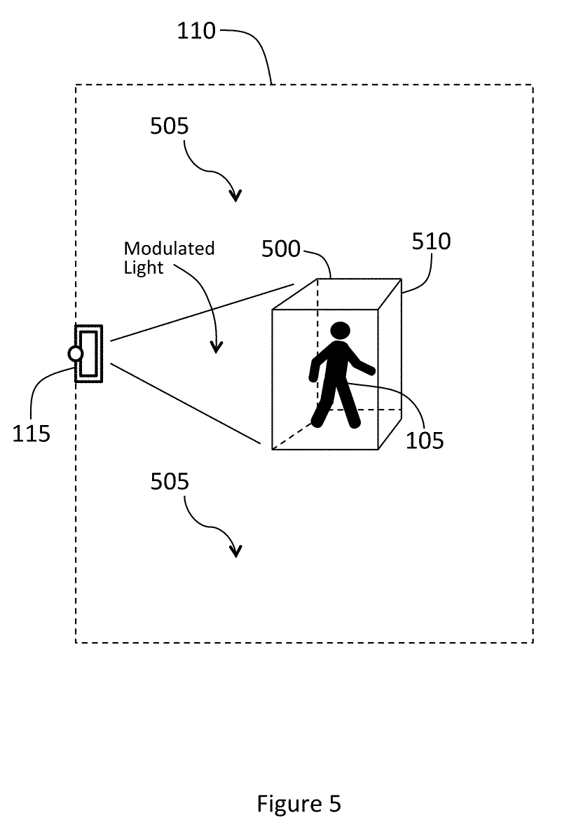

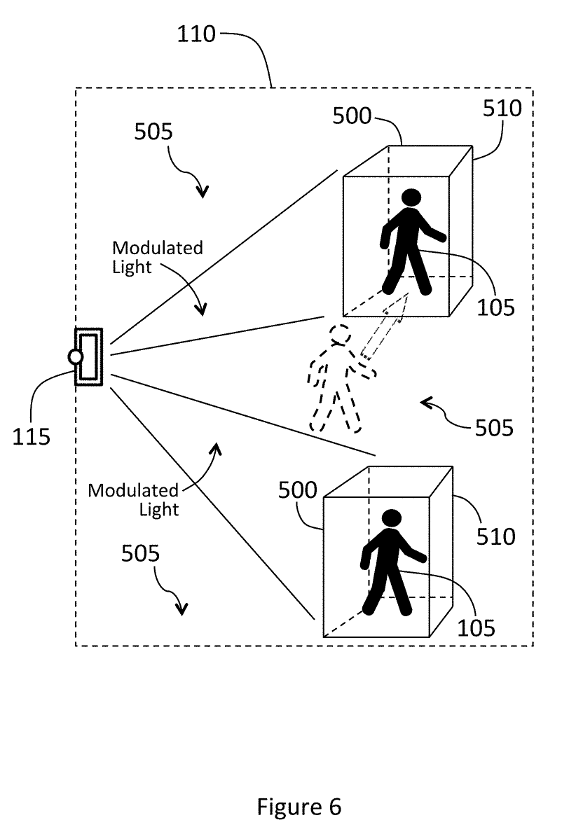

In one embodiment, the main processor 320 may use the tracking data from the other sensors of the passive-tracking system 115 (or other device or system) to selectively spatially control the modulated light in the monitoring area 110. Referring to FIGS. 5 and 6, examples of a monitoring area 110 with one and two human objects 105 (respectively) are shown. Reference will also be made to FIG. 4 for purposes of the description related to FIGS. 5 and 6. In these examples, the processor 320 may have obtained X, Y, and Z coordinates (or any combination thereof) with respect to the human objects 105. Based on this information, the processor 320, in this example, may signal the controller 415 to cause the SLM 410 to spatially control the modulated light by reducing the amount of light reaching areas that are unoccupied by the human objects 105.

For example, referring to the passive-tracking system 115 in FIG. 5, the SLM 410 of the ToF sensor 310 may be initially operating in a diffusive-emission mode. The system 115 may also be operating in a monitoring area 110. A human object 105 may enter the monitoring area 110, and the system 115, in view of the data collected by any combination of its sensors, may begin to passively track the human object 105. Other non-human objects 105, such as office equipment or furniture (not shown), may also be positioned in the monitoring area 110. In this example, the non-human objects 105 are not suitable for passive tracking. Based on the positional data received from the sensors, the main processor 320 may determine a location of the human object 105 in the monitoring area 110.

The processor 320 may also be configured to identify one or more high-interest and low interest vicinities in the monitoring area 110. This identification may be based on the number and type of objects 105 that are suitable for passive tracking and their location in the monitoring area 110. For example, the vicinity of the monitoring area 110 occupied by the human object 105 may be identified as a high-interest vicinity 500, while the remaining portions of the area 110 unoccupied by the human object 105 may be considered low-interest vicinities 505. Objects 105 that are not suitable for passive tracking may or may not occupy low-interest vicinities 505.

A high-interest vicinity 500 may be defined by any suitable parameters, factors, or characteristics. For example, the main processor 320 may rely on the positional data associated with the human object 105 that it receives to construct a digital representation that corresponds to a high-interest vicinity 500 of the monitoring area 110. As a specific example, knowing the X, Y, and Z coordinates of the human object 105, the processor 320 may generate a digital representation that can correspond to a virtual three-dimensional (3D) volume 510 in the monitoring area 110. This volume 510 may define or otherwise serve as the basis for a high-interest vicinity 500 in the monitoring area 110. As shown here, the high-interest vicinity 500 may essentially match the scope of the volume 510, although the vicinity 500 may be different in size, if desired. In one example, the X, Y, and Z coordinates (or other combinations of such coordinates) may correspond to an approximate center of the human object 105, although other parts of the human object 105 or even locations external to the human object 105 may serve as the reference point for the coordinates. The approximate center of the human object 105 may be, for example, the centroid of the image occupied by a human, which may involve an attempt to estimate the center of mass.

The overall size and shape of the volume 510 may be determined in any suitable manner. For example, using the X, Y, and Z coordinates as a reference, the volume 510 may be defined by an average physical size of a human, as the object 105 in this example is a human object 105. Any suitable number and type of physical dimensions for an average adult may be used to determine the boundaries of the volume 510 and, hence, the high-interest vicinity 500. In another example, the tracking data associated with the human object 105 may include information about the physical size of the human object 105, and the processor 320 can use it to identify the high-interest vicinity 500. As an option, if the human object 105 is carrying some other object 105, like a child or a package, or wearing another object 105 or is positioned near another object 105, the identification of the high-interest vicinity 500 may take this additional object 105 into account. Moreover, if the tracking data indicates that the human object 105 is in or adjusts to a particular orientation or posture, such as a seated position, the high-interest vicinity 500 may be correspondingly defined or adjusted.

In some cases, the tracking data associated with the human object 105 may only include data related to the X and Y coordinates of the human object 105. In such a scenario, the main processor 320 may generate an estimated Z coordinate for purposes of defining the high-interest vicinity 500 with respect to the human object 105. As an example, the Z coordinate may be based on previous Z coordinates realized from tracking data associated with other human objects 105 in the monitoring area 110, with, for example, more weight given to locations typically occupied by humans in the monitoring area 110. This feature may apply to other coordinates that may not be available, such as in the case of the tracking data only including data related to the X and Z coordinates, the Y and Z coordinates, or even a single coordinate.

In one embodiment, the high-interest vicinity 500 may be defined such that the human object 105 is completely contained within its boundaries. If desired, the high-interest vicinity 500 may be defined to include other objects 105 that may be related to the human object 105, such as if the human object 105 is carrying or standing near the other object 105. To ensure compliance with this particular setting, the initial size of the 3D volume 510 may be increased by a certain percentage to realize a high-interest vicinity 500 that takes up more space than it normally would. Increasing the size of the high-interest vicinity 500 in this manner may help ensure that a sufficient amount of modulated light reaches the human object 105.

As an option, the high-interest vicinity 500 may not necessarily encompass the entire human object 105. For example, an appendage (like a leg or arm) or a portion of one may not be within the high-interest vicinity 500, as defined. In another example, a plurality of high-interest vicinities 500 may be defined in which each one encompasses some portion of the human object 105. As such, a vicinity in the monitoring area 110 may be a high-interest vicinity 500 if it covers at least some portion of a human object 105 or some other object 105 suitable for passive tracking.

In an alternative embodiment, the main processor 320 may not necessarily be configured to identify high-end vicinities 500 with such precision. For example, based on the positional information of the human object 105 acquired from the tracking data, the processor 320 can simply define a high-interest vicinity 500 in an arbitrary manner, with the focus of the high-interest vicinity 500 being on the positional information. More specifically, the processor 320 may identify a certain space (of any shape or size) around the coordinates of the human object 105, such as the case where the coordinates correspond to a center of the human object 105. This space may serve as the 3D volume 510. As an example, the processor 320 may identify a substantially spherical space around the coordinates having a radius of a predetermined distance extending from the coordinates. Other shapes may be used for this purpose, and whatever space is identified as a high-interest vicinity 500 in this manner may be adjusted based on certain factors. For example, if the coordinates of the human object 105 are near a wall or some other structure that would impede the motion of the human object 105, the processor 320 may correspondingly modify the shape of the high-interest vicinity 500. This adjustment may prevent the wall or other structure from being within the high-interest vicinity 500. In addition, the reference frames related to the monitoring area 110 may identify the wall or other structure as objects 105 that are unsuitable for passive tracking, and the processor 320 may use this information to adjust the shape of a high-interest vicinity 500.

As another example, the monitoring area 110 may be sectioned into one or more predetermined vicinities. This sectioning step may occur when the ToF sensor 310 (or passive-tracking system 115) is initialized. These vicinities may be fixed, although they may be adjusted periodically. Depending on the positional information of the human object 105, the processor 320 may identify one or more of the predetermined vicinities as high-interest vicinities 500. As will be shown later, no matter how the high-interest vicinities 505 are defined, the processor 320 may adjust them after their initial setting, such as after receiving and processing modulated light reflected off the human object 105.

In yet another example, the main processor 320 may not necessarily rely on a 3D volume 510 for the purpose of identifying a high-interest vicinity 500. In particular, the main processor 320, based on the positional data associated with the human object 105, may simply define a virtual two-dimensional plane (not shown), with whatever coordinates are available for the human object 105 to be the approximate center of the plane. In this case, the 2D plane may not necessarily define the high-end vicinity 500, as the vicinity 500 may be a 3D space in the monitoring area 110; however, the plane may serve as the basis for identifying a high-end vicinity 500. In this case, the boundaries of the high-end vicinity 500 may originate from this plane, with the processor 320 making approximations to do so. As will be shown below, the high-interest vicinity 500 may be adjusted based on data that is returned from the incoming frames. In another example, the SLM 410 may be configured for one-dimensional (1D) operation in which only vertical stripes are individually controlled. In such a setup, only an X coordinate may be required for identifying a high-interest vicinity 500.

As noted earlier, the low-interest vicinity 505 may be a vicinity of the monitoring area 110 that is unoccupied by an object 105 that is suitable for passive tracking. In the example above, the vicinities of the monitoring area 110 unoccupied by at least some part of the human object 105 may be identified as low-interest vicinities 505. In one arrangement, the low-interest vicinities 505 may encompass substantially all the monitoring area 110 not held by a high-interest vicinity 500. Alternatively, the low-interest vicinities 505 may only take up a portion of the monitoring area 110 not done so by a high-interest vicinity 500. In either case, the area covered by a low-interest vicinity 505 may be done by a single low-interest vicinity 505 or a plurality of them. Moreover, if the shape of a high-interest vicinity 500 is modified, the shape of one or more of the low-interest vicinities 505 may be correspondingly adjusted. As will be shown below, the shape of the high-interest vicinities 500 and the low-interest vicinities 500 and, hence, the space of the monitoring area 110 that they occupy may change as the human object 105 moves in the monitoring area 110.

As previously mentioned when introducing FIG. 5, the SLM 410 of the ToF sensor 310 may be initially operating in a diffusive-emission mode. In this mode, the SLM 410 may avoid spatially controlling the modulated light, and the light may be diffusively emitted. Once the passive-tracking system 115 begins to passively track the human object 105 and the high-interest vicinity 500 and the low-interest vicinities 505 are identified, the main processor 320 may signal the SLM 410 to transition to the controlled-emission mode. In this mode, the SLM, under the direction of the processor 320, may spatially control the modulated light by reducing the amount of modulated light reaching the low-interest vicinities 505 while the human object 105 occupies the high-interest vicinity 500. In this example, the portion of the modulated light to be projected to the high-interest vicinity 500 may be substantially unaffected in this mode, thereby maintaining the diffusive emission of the modulated light with respect to the high-interest vicinity 500.

In contrast, simultaneous to maintaining the diffusive emission of the modulated light with respect to the high-interest vicinity 500, the portion of the modulated light to be projected to the low-interest vicinities 505 may be blocked in some manner. As such, the diffusive emission of the modulated light with respect to the low-interest vicinities 505 may cease. As noted above, examples of blocking the portion of the modulated light to be projected to the low-interest vicinities 505 include directing the light to a light dump or absorbing it.

Depending on how precise the projector 425 is, the coverage area of the portion of the modulated light projected to the high-interest vicinity 500 may approximately match that of the high-interest vicinity 500. Similarly, the portion of the modulated light that is at least substantially prevented from reaching the low-interest vicinities 505 may approximately correspond to the coverage area of the low-interest vicinities 505 of the monitoring area 110. In other words, if this light were to be projected in the diffusive emission mode, the coverage area of the light would approximately match the space covered by the low-interest vicinities 505. Nevertheless, deviations, whether intentional or not, may cause at least some mismatching in the coverage areas of the projected or blocked light in comparison to those of the high-interest vicinities 500 and the low-interest vicinities 505, respectively. Based on the data generated by the reflections of the modulated light (and possibly other tracking data), the processor 320 may tune the SLM 410 or make other adjustments to improve such matching or correspondence.

At least some of the modulated light that reaches the human object 105 may be reflected back to the ToF sensor 310 and captured by the imaging sensor 370. Because the modulated light that would have been projected to the low-interest vicinities 505 may be substantially blocked, the reflections of the modulated light that normally would have originated from interactions with insignificant objects 105, such as walls or furniture, in the monitoring room 110 may be significantly reduced. Such insignificant objects 105 may include objects 105 that the passive-tracking system 115 has deem unworthy of being passively tracked. Accordingly, because of the reduction of these extraneous reflections, the degradations in performance arising from MPP may be avoided.

The imaging sensor 370 may forward the data it generates from the received reflections to the main processor 320, which may determine positional information associated with the human object 105. As an example, the processor 320 may determine at least a depth distance for the human object 105 with respect to the ToF sensor 310, which can enable the processor 320 to provide Z coordinate for the human object 105. (The data from the sensor 370 may also enable the processor to determine X and Y coordinates for the human object 105.) This positional information may be used to complete a full set of positional coordinates associated with the human object 105 in which at least some of the set originates from other sensors of the passive-tracking system 115. Such information may also be used to confirm coordinates that are realized from the other sensors.

No matter the source of the positional information, the main processor 320 may use this data to make adjustments the projector 425. For example, new tracking data that is received may be more accurate than a previous set, and the processor 320 may signal the SLM 410 or some other component of the projector 425 (or ToF sensor 310) to adjust its operation. In the case of the SLM 410, the SLM 410 may spatially control different portions of the modulated light to ensure more of the light is diffusively emitted to the high-interest vicinity 500 or less of it diffusively emitted to the low-interest vicinities 505 (or both). As an example, the processor 320 can be configured to execute these adjustments continuously or at certain intervals during the operation of the SLM 410 in the controlled-emission mode.

In one arrangement, if the tracking data indicates that the human object 105 is no longer in the monitoring area 110, the main processor 320 may signal the SLM 410 to transition from the controlled-emission mode to the diffusive-emission mode, which may stop the spatial control of the modulated light. Following the transition, the ToF sensor 310 may establish (again) the diffusive emission of the modulated light in the monitoring area 110. Of course, if some other object 105 is present in the monitoring area 110 or enters the area 110 in the future, the SLM 410 may remain in or transition back to the controlled-emission mode. When establishing the diffusive emission of modulated light, this reference may include establishing the diffusive emission again (after an initial step of doing so) or for the first time with respect to some cycle or other stage.

In one arrangement and as shown above, the spatial control applied to the modulated light from the ToF sensor 310 may be based (either completely or partially) on the tracking data provided by the frames generated by one or more other sensors of the passive-tracking system 115. This tracking data may be helpful in initially identifying the vicinities of the monitoring area 110 and correspondingly reducing the amount of modulated light reaching them. In this case, the tracking data relied on for the initial operational settings may be exclusively based on the tracking data from the other sensors such as the visible-light sensor 300, the thermal sensor 315, and the sonar device 355 (or any other combination thereof). Once the ToF sensor 310 applies the initial spatial control to the modulated light, the main processor 320 may also rely on the tracking data from the other sensors to adjust the spatial control.

As another example, following the initial spatial control, the processor 320 may rely on tracking data from both the ToF sensor 310 and the other sensor(s) of the passive-tracking system 115 or exclusively from the ToF sensor 310. In the case of the former, the ToF sensor 310 may provide tracking data to obtain a Z coordinate of the human object 105, while the X and Y coordinates may originate from tracking data generated by the other sensors, such as the visible-light sensor 300 and the thermal sensor 315. In addition, some of the tracking data generated by the ToF sensor 310 can be used to confirm or adjust the tracking data from the other sensors. For example, X and Y coordinates may be acquired from the data of the ToF sensor 310, and they may confirm or adjust the X and Y coordinates from the data of the visible-light camera 300 and the thermal sensor 315.

In another embodiment, the ToF sensor 310 may operate in a self-sufficiency mode in which it effectively relies on its own tracking data to set or adjust the spatial control of the modulated light. For example, in an initial operational stage, such as prior to the presence (or detection) of a human object 105 in the monitoring area 110, the ToF sensor 310 may diffusively emit the modulated light in the monitoring area 110. If, for example, a human object 105 enters the monitoring area 110, the light reflected off it may enable the main processor 320 to determine that a potential candidate for passive tracking is currently in the monitoring area 110. In such a case, the processor 320 may identify the high-interest vicinity 500 and the low-interest vicinities 505 and signal the SLM 410 (through the controller 405) to correspondingly spatially control the modulated light, as descried above. The processor 320 may also rely on future tracking data from the ToF sensor 310 to make any necessary adjustments to achieve optimal results.

To be clear, the tracking data used to spatially control the modulated light may come from any suitable type and combination of sensors, including a single sensor. Moreover, the combination of sensors used to provide the tracking data may be changed at any time. This feature may be useful if a sensor malfunctions or is otherwise providing unreliable data. These principles with respect to tracking data may apply to circumstances where an object 105 being passively tracked moves in the monitoring area 110. Additional material on this topic will be presented below.

Referring to FIG. 6, the human object 105 may still be present in the monitoring area 110 but has moved to a new location. In addition a new human object 105 has entered the monitoring area 110 (the object 105 closer to the bottom of the drawing). Focusing on the original human object 105, the tracking data associated with the original human object 105 may provide positional information related to the new location. This new positional information may be gleaned from the tracking data of any of the sensors of the passive-tracking system 115. In response, the main processor 320, in accordance with the description above, may identify one or more new high-interest vicinities 500 and new low-interest vicinities 505 for the original human object 105. In this example, because the original human object 105 may have moved away from and outside the original high-interest vicinity 500, the original high-interest vicinity 500 may be identified as a (new) low-interest vicinity 505, as the original human object 105 may no longer occupy it. If so, the new low-interest vicinity 505 may simply be absorbed into and be considered part of a pre-existing low-interest vicinity 505. If, however, at least a portion of the original human object 105 remains within the scope of the original high-interest vicinity 500, it may remain identified as a high-interest vicinity 500. As another example, the overall space covered by the original high-interest vicinity 500 may be modified (such as enlarged or reduced) based on changes in the portion of the original human object 105 that the original vicinity 500 now covers.

Moreover, one or more original low-interest vicinities 505 (or portions thereof) may be identified as (new) high-interest vicinities 500, if at least some part of the original human object 105, based on its movement, is now within the original spaces (or portions thereof) of these vicinities 505. As part of this process and as described above, at least some part of the monitoring area 110, such as a 3D volume 510, may serve as the basis for the new high-interest vicinity 500. As the main processor 320 receives updated tracking data, the high-interest vicinities 500 and the low-interest vicinities 505 may be correspondingly adjusted.

Based on the changes in the spaces of the monitoring area 110 that are deemed significant for passively tracking the original human object 105, the main processor 320 may signal the SLM 410 to correspondingly make adjustments in how the modulated light is spatially controlled. For example, the SLM 410 may cease the diffusive emission of the modulated light with respect to an original high-interest vicinity 500 by blocking the light from reaching the vicinity 500 if it has been re-identified as a (new) low-interest vicinity 505. Similarly, the SLM may establish (again) the diffusive emission of the light with respect to an original low-interest vicinity 505 if that vicinity 505 has been re-identified as a (new) high-interest vicinity 500. Establishing the diffusive emission of the modulated light may be done by no longer blocking the relevant portion of the modulated light.

Updates to the control applied to the modulated light can be carried out in effectively a one-to-one correspondence with the adjustments to the high-interest vicinities 500 and the low-interest vicinities 505. In another example, the movement of the original human object 105 may need to reach a predetermined threshold, whether in terms of overall degree of movement or distance with respect to an original position, before effecting changes in the spatial control of the modulated light. For example, if the original human object 105 simply moves from a standing to a seated position in approximately the same location or moves a short translational distance, the main processor 320 may determine that the SLM 410 is not required to make any adjustments to the current spatial control of the modulated light.

As noted above, the movement of the original human object 105 can be tracked with any of the sensors of the passive-tracking system 115. For example, based on the received reflections of modulated light, the main processor 320 may be able to detect the movement and estimate a speed and direction of the original human object 105. Based on this information, the SLM 410, in view of the newly identified high-interest vicinities 500 and low-interest vicinities 505, may then adjust its spatial control of the modulated light. By continuously acquiring information from the reflections of the modulated light, the SLM 410 may continue to make any necessary adjustments to achieve optimal results.

As another option, if the main processor 320 is unable to determine a satisfactory estimate of the speed and direction of the original human object 105, the processor 320 can direct the SLM 410 to perform trial-and-error adjustments in an effort to estimate the location of the original human object 105. In this case, the processor 320 may be unable to identify accurately the high-interest vicinities 500 or the low-interest vicinities 505. The trial-and-error adjustments may involve both diffusively emitting and blocking some portions of the modulated light based on known limits of human speed and known restrictions in the monitoring area 110 that may impede the movement of the original human object 105 in a particular direction. Examples of such impediments in the monitoring area 110 include walls or furniture. If an initial adjustment of the modulated light results in readings of poor quality (from MPP), the SLM 410 can try one or more other adjustments until the performance improves.

As mentioned above, a new human object 105 may have entered the monitoring area 110. Tracking data associated with the new human object 105 may be received, and the SLM 410 may spatially control the modulated light with respect to the new human object 105 in accordance with the processes and examples previously presented. As such, the appearance of the new human object 105 may cause the main processor 320 to transition one or more low-interest vicinities 505 to (new) high-interest vicinities 500. Additional transitions may occur if the new human object 105 moves in the monitoring area 110. In this case, the SLM 410 may be required to reduce the amount of modulated light reaching insignificant spaces of the monitoring area 110 and establish it for other spaces with respect to multiple targets, simultaneously. This process can be carried out for any number of objects 105 in the monitoring area 110, and depth distances may be determined for all or at least a portion of them.

If multiple objects 105 are located within a certain distance of one another in the monitoring area 110, the main processor 320 may, for example, merge one or more of the high-interest vicinities 500 related to the objects 105. This merging may occur if at least some portion of the scopes of the relevant high-interest vicinities 500 overlap or are within a certain spacing of one another. The SLM 410 may, in turn, perform corresponding adjustments to its spatial control of the modulated light. If the multiple objects 105 move apart from one another, such as beyond the certain distance, the main processor 320 may re-identify new high-interest vicinities 500 (if necessary) and signal the SLM 410 to make any necessary adjustments to the spatial control of the modulated light.

In some cases, the tracking data associated with an object 105 may indicate that the object 105 has moved beyond a predetermined distance threshold. As an example, this indication may be based on the depth distance of the object 105. In accordance with the description herein, the SLM 410 may correspondingly adjust the spatial control of the modulated light, if necessary. In addition, as an option, the main processor 320 may cause the intensity of the modulated light emitted from the modulated light source 345 to increase. As an example, the intensity may be increased gradually or based on a step function. The SLM 410 may continue its spatial control, but the intensity of the diffusively emitted modulated light maintained with respect to the high-interest vicinity 500 may be increased. This step can raise the chances that acceptable reflections of the modulated light off the object 105 may be captured. Nevertheless, because the SLM 410 can continue to reduce the light reaching the unimportant sections of the monitoring area 110, the increased intensity may not have a negative effect on MPP. If, for example, the tracking data shows that the object 105 has moved within the predetermined distance threshold, the changes to the intensity of the modulated light may be correspondingly reversed.

Although many of the examples of this description list a human as the object 105 in question, the description is not so limited. Other objects 105, including animals and machines, may be passively tracked, and modulated light from the ToF sensor 310 may be spatially controlled with respect to these objects 105.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein.

Furthermore, arrangements described herein may take the form of a computer program product embodied in one or more computer-readable media having computer-readable-program code embodied (e.g., stored) thereon. Any combination of one or more computer-readable media may be utilized. The computer-readable medium may be a computer-readable signal medium or a computer-readable storage medium. The phrase “computer-readable storage medium” is defined as a non-transitory, hardware-based storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Program code embodied on a computer-readable storage medium may be transmitted using any appropriate systems and techniques, including but not limited to wireless, wireline, optical fiber, cable, RF, etc., or any suitable combination of the foregoing. Computer program code for carrying out operations for aspects of the present arrangements may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects herein can be embodied in other forms without departing from the spirit or essential attributes thereof. Accordingly, reference should be made to the following claims, rather than to the foregoing specification, as indicating the scope hereof.

What is claimed is:

1. A time-of-flight sensor for reducing multipath propagation, comprising:
a light source configured to emit modulated light in a monitoring area;
a projector optically coupled to the light source, wherein the projector is configured to receive the modulated light and to project the modulated light in the monitoring area; and
a processor that is communicatively coupled to the projector, wherein the processor is configured to:
receive tracking data from one or more sensors of a passive tracking system, wherein the tracking data is associated with an original object in the monitoring area being passively tracked by the passive tracking system and wherein the monitoring area comprises one or more high-interest vicinities and low-interest vicinities and the original object occupies at least one of the high-interest vicinities and is outside the low-interest vicinities;
based on the tracking data, signal the projector to selectively spatially control the modulated light in the monitoring area by reducing the amount of modulated light reaching the low-interest vicinities of the monitoring area while the original object occupies the high-interest vicinity.

2. The time-of-flight sensor of claim 1, wherein the projector comprises:
a homogenizing lens system optically coupled to the light source;
a spatial light modulator optically coupled to the homogenizing lens system; and
an objective lens system optically coupled to the spatial light modulator.

3. The time-of-flight sensor of claim 2, wherein the homogenizing lens system is configured to provide a uniform pattern of illumination with respect to the modulated light for the spatial light modulator, wherein the spatial light modulator is configured to reduce the amount of modulated light reaching the low-interest vicinities of the monitoring area by selectively blocking the modulated light prior to the modulated light reaching the objective lens, and wherein the objective lens is configured to project the modulated light that is not blocked by the spatial light modulator.

4. The time-of-flight sensor of claim 3, wherein the spatial light modulator is further configured to selectively block the modulated light by directing at least a portion of the modulated light to a light dump or by absorbing at least a portion of the modulated light.

5. The time-of-flight sensor of claim 1, further comprising an imaging sensor configured to receive reflections of the modulated light, wherein the processor is communicatively coupled to the imaging sensor and is further configured to determine a depth distance of the original object based on data generated from the received reflections of the modulated light.

6. The time-of-flight sensor of claim 1, wherein the high-interest vicinity occupied by the original object is an original high-interest vicinity and wherein the processor is further configured to, as part of receiving tracking data from the sensors of the passive-tracking system, receive tracking data associated with the original object indicating that the original object has moved from the original high-interest vicinity.

7. The time-of-flight sensor of claim 6, wherein the processor is further configured to:
determine, in response to the original object moving from the original high-interest vicinity, that the original high-interest vicinity is a new low-interest vicinity unoccupied by the original object; and
as part of signaling the projector to selectively spatially control the modulated light in the monitoring area, signal the projector to selectively spatially control the modulated light in the monitoring area by reducing the amount of modulated light reaching the new low-interest vicinity.

8. The time-of-flight sensor of claim 1, wherein the processor is further configured to:
as part of receiving tracking data from the sensors of the passive-tracking system, receive tracking data associated with the original object indicating that the original object has moved to occupy a low-interest vicinity;
determine that the low-interest vicinity occupied by the original object is a new high-interest vicinity; and
in response to the determination, signal the projector to cease the reduction of modulated light with respect to the new high-interest vicinity.

9. The time-of-flight sensor of claim 1, wherein the time-of-flight sensor is a sensor that is part of the passive tracking system and the one or more sensors of the passive tracking system include the ToF sensor, a visible-light sensor, a thermal sensor, or a sonar device.

10. The time-of-flight sensor of claim 1, wherein the original object is a human and the processor is further configured to:
receive tracking data from the sensors that indicates the lack of presence of the human; and
in response to the lack of presence of the human, signal the projector to cease selectively spatially controlling the modulated light in the monitoring area.

11. The time-of-flight sensor of claim 1, wherein the processor is further configured to:
receive from the sensors tracking data associated with a new object in the monitoring area being passively tracked by the passive tracking system at the same time as the original object, wherein the new object occupies at least one of the high-interest vicinities and is outside the low-interest vicinities; and
based on the tracking data associated with the original object and the new object, signal the projector to selectively spatially control the modulated light in the monitoring area by reducing the amount of modulated light reaching the low-interest vicinities of the monitoring area while both the original object and the new object occupy the high-interest vicinities.

12. A method for reducing multipath propagation, comprising:
diffusively emitting modulated light in a monitoring area for the purpose of determining depth distances;
determining that an object is present in the monitoring area;
in response to determining that the object is present, passively tracking the object;
identifying a vicinity occupied by the object as a high-interest vicinity and vicinities unoccupied by the object as low-interest vicinities;
maintaining the diffusive emission of the modulated light with respect to the high-interest vicinity;
simultaneous to maintaining the diffusive emission of the modulated light with respect to the high-interest vicinity, ceasing the diffusive emission of the modulated light with respect to the low-interest vicinities such that the amount of modulated light reaching the low-interest vicinities is reduced; and
determining a depth distance of the object.

13. The method of claim 12, wherein ceasing the diffusive emission of the modulated light with respect to the low-interest vicinities such that the amount of modulated light reaching the low-interest vicinities is reduced comprises blocking the modulated light by directing at least a portion of the modulated light to a light dump or by absorbing at least a portion of the modulated light.

14. The method of claim 12, further comprising:
determining that the depth distance of the object is equal to or greater than a predetermined distance threshold; and
in response, increasing the intensity of the diffusively emitted modulated light maintained with respect to the high-interest vicinity.

15. The method of claim 12, further comprising:
determining that the object is occupying a low-interest vicinity and identifying the low-interest vicinity as a new high-interest vicinity and the previous high-interest vicinity as a new low-interest vicinity based on the object no longer occupying the previous high-interest vicinity;
in response to identifying the new high-interest vicinity, re-establishing the diffusive emission of the modulated light with respect to the new high-interest vicinity; and
in response to identifying the previous high-interest vicinity as a new low-interest vicinity, ceasing the diffusive emission of the modulated light with respect to the new low-interest vicinity such that the amount of modulated light reaching the new low-interest vicinity is reduced.

16. The method of claim 12, further comprising:
determining that a new object is present in the monitoring area at the same time as the original object;
identifying a low-interest vicinity occupied by the new object as a new high-interest vicinity and vicinities unoccupied by both the new object and the original object as low-interest vicinities;
maintaining the diffusive emission of the modulated light with respect to the high-interest vicinity associated with the original object and establishing the diffusive emission of the modulated light with respect to the new high-interest vicinity associated with the new object;
simultaneous to maintaining the diffusive emission of the modulated light with respect to the high-interest vicinity associated with the original object and re-establishing the diffusive emission of the modulated light with respect to the new high-interest vicinity associated with the new object, ceasing the diffusive emission of the modulated light with respect to the low-interest vicinities unoccupied by both the new object and the original objects such that the amount of modulated light reaching the low-interest vicinities is reduced; and
determining a depth distance of the new object.

17. The method of claim 12, further comprising:
determining that the object is no longer present in the monitoring area; and
in response, establishing the diffusive emission of modulated light in the monitoring area.

18. A method of reducing the effects of multipath propagation arising from the operation of a time-of-flight sensor, comprising:
diffusively emitting from the time-of-flight sensor modulated light in a monitoring area;
receiving tracking data associated with an object in the monitoring area;
analyzing the tracking data to identify low-interest vicinities of the monitoring area, wherein a low-interest vicinity is a vicinity of the monitoring area unoccupied by the object;
in response to the identification of the low-interest vicinities, transitioning the diffusive emission of the modulated light to a spatially controlled emission of the modulated light by preventing the modulated light from being directed to the low-interest vicinities;
receiving reflections of the modulated light from the object; and
based on the received reflections, providing a depth distance of the object in the monitoring area.

19. The method of claim 18, further comprising:
analyzing the tracking data to identify a high-interest vicinity of the monitoring area, wherein the high-interest vicinity is a vicinity of the monitoring area occupied by the object; and
maintaining the diffusive emission of modulated light with respect to the high-interest vicinity.

20. The method of claim 18, further comprising:
determining that the object is no longer present in the monitoring area; and
in response, transitioning back to the diffusive emission of the modulated light such that the spatially controlled emission of the modulated light is stopped.
